(19) United States
(12) Patent Application Publication
(10) Pub. No.: US 2020/0220373 A1
(43) Pub. Date: Jul. 9, 2020

(54) PORTABLE WIRELESS CHARGING

(71) Applicant: HEWLETT-PACKARD DEVELOPMENT COMPANY, L.P., SPRING, TX (US)

(72) Inventors: SARA R. FERRIS, Houston, TX (US); DIMITRE D MEHANDJIYSKY, Cypress, TX (US); MICHAEL C. BARTHA, Vancouver, WA (US)

(21) Appl. No.: 16/633,989

(22) PCT Filed: Sep. 13, 2017
(86) PCT No.: PCT/US2017/051362

§ 371 Date: Jan. 24, 2020

(51) Int. Cl. H02J 7/02; H02J 50/10; G06F 3/0354

(52) U.S. Cl. CPC H02J 7/02; G06F 3/03545; H02J 50/10

(57) ABSTRACT

The portable wireless charging systems discussed herein may comprise an e-pen comprising a plurality of functionalities, a jog, and a charging mat. In a first state of the wireless charging system, the e-pen is to couple to the jog and to maintain a functionality of the plurality of functionalities while the e-pen is coupled to the jog. In a second state of the wireless charging system, the e-pen is to couple to the jog and the jog is to couple to the charging mat, and the charging mat is to generate a fluctuating current to be received by the e-pen, and the e-pen is to maintain the at least one functionality of the plurality of functionalities.

### BACKGROUND

An increasing speed of data transmission via networks has led to the increased use of various electronic devices that may employ battery power to execute data transmission and modification. Electronic devices use various types of batteries and charging devices, including cables and chargers. Different electronic devices may hold their respective charges for varying amounts of time depending upon a user's patterns of device use and a device's capabilities for power storage and use.

### BRIEF DESCRIPTION OF THE DRAWINGS

Various examples will be described below referring to the following figures:

FIG. 1 is a partial schematic cross-section of an example electronic pen 100.

FIG. 2 is a partial schematic illustration of an example of a jog 200 according to certain examples of the present disclosure.

FIGS. 3A and 3B are partial schematic illustrations of a charging mat 300 (“mat”) according to certain examples of the present disclosure.

FIG. 4 is a partial schematic illustration of an example wireless charging system 400.

FIG. 5 is a partial schematic illustration of an example wireless charging system 500.

FIG. 6 is a partial schematic illustration of an example wireless charging system 600.

FIG. 7 is a partial schematic illustration of an example wireless charging system 700.

FIG. 8 is a partial schematic illustration of an example wireless charging system 800.

FIG. 9 is an example method 900 of a portable wireless charging system.

FIG. 10 is an example method 1000 of a portable wireless charging platform.

FIGS. 11A-11D are partial schematic illustrations of a portable wireless charging system's example transformation from a closed pouch at FIG. 11A to a collapsed tray at FIG. 11D.

FIGS. 12A-12C depict an example transformation of a portable wireless charging system from a first tray state to a second pouch state.

### DETAILED DESCRIPTION

Current interactive technologies, including virtual whiteboards, gaming technology, design and drafting, art boards, and web browsing, may employ peripheral devices that enable users to interact with the interactive technology directly (contact) or indirectly (wirelessly and contactlessly). These interactive technologies may comprise sensors such as gesture, motion, biometric, geolocation, level, and other sensors or an interactive surface with which the peripheral devices interact. As discussed herein, a “peripheral device” may be a device that interacts with a computing device including computing devices such as a tablet, wearable technology, mobile phones, personal digital assistant, laptop computer, desktop computer, or other interactive surface or technology by transmitting data to and/or receiving data from the interactive surface or technology. Examples of peripheral devices include electronic pens (e-pens) and other drafting and design devices, devices that provide wireless charges (“charging devices”), selection input devices such as mice or track pads, gaming input devices such as joysticks, controllers, track pads, wheels, and sports equipment, and other devices that electrically, communicatively, and/or mechanically couple to a computing device. Peripheral and computing devices may comprise various functionalities used to transmit and receive data, create content, modify content, select content, view content, delete content, or perform other functions while a plurality of functionalities are loaded and at least one functionality is executing (active) on the device.

Described herein are portable wireless charging platforms that fully or partially charge devices while users are on the go and may charge the devices simultaneously with use of the device(s). That is, the portable wireless charging platforms described herein enable a first device to charge a second device while one or both devices is simultaneously employed for functionalities other than charging. These devices may be collectively referred to as chargeable devices and may include computing devices such as a tablet, mobile phone, personal digital assistant, laptop computer, desktop computer, or other interactive surface or technology or peripheral devices such as an electronic pen, a joystick or other gaming devices, selection tools including the jogs discussed herein, and mats that may range in size from a few square inches in area to large enough to fill a room (for example, a 10′×10′ mat). In some examples discussed herein, a mat such as a charging mat may be operable to receive inputs from other peripheral devices and/or inputs from a user, even while those peripheral devices are receiving a charge from the mat. Thus, discussed herein are various embodiments of portable wireless charging systems that may take a plurality of forms depending upon the example. These portable wireless charging systems enable a user to have reliably charged devices and methods of charging and maintaining charges on those devices without compromising the functionality of the devices during charging or while providing charge to other devices.

As discussed herein, an “interactive surface” comprises any substrate or combination of substrates capable of communicating with peripheral devices to display markings resulting from the communication between the surface and the peripheral device. This is in contrast to a conventional writing surface, such as paper, a whiteboard, or a blackboard, where the markings may be left by a peripheral device such as a marker or piece of chalk. As used herein, the term “markings” may be used to collectively describe freehand-originated features such as text, drawings, stamps, images, and typeface text that may be imported from peripheral devices, as well as combinations thereof. Thus, a marking would include an image imported to an interactive surface that is then modified by, for example, freehanded writing to emphasize, modify, or deemphasize various features of the image.

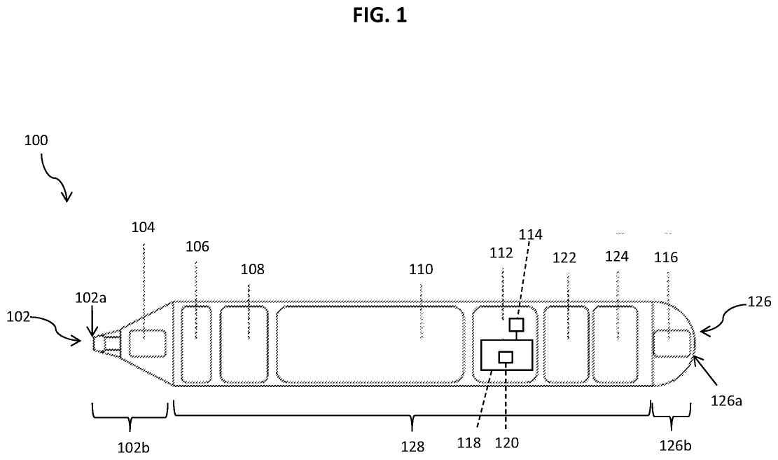

As used herein, a “charging mat” is a device capable of providing a fluctuating current to a peripheral device while simultaneously receiving inputs from a first peripheral device and transmitting those inputs to a second peripheral or computing device while the first peripheral device is charging. The charging mats described herein may range in size as discussed above. In one example, a charging mat is to couple to a jog and an e-pen. The charging mat may couple to various peripheral and computing devices via mechanical, electrical, and communicative means, alone or in combination, as discussed herein. As used herein, a “jog” is a peripheral device that may comprise various functionalities including selection and creation of markings. In one example, the jog may be wirelessly charged via the mat, and the jog may also be removably coupled to an e-pen, discussed in detail at least in FIG. 1 below, while the jog is charging and/or executing a functionality such as the selection or the creation or modification of markings. In some examples herein, two or more computing or peripheral devices may be referred to as “removably coupled” to each other when the devices are mechanically, electrically, and/or communicatively (i.e., able to transmit and/or receive data) coupled such that uncoupling the two or more devices does not render the devices unusable. Although uncoupling may cause one or more devices to cease charging, it does not compromise the ability of the uncoupled device(s) to be charged at a later point and does not damage or compromise functionalities of the device(s).

The functionalities described herein as being executed by or via the charging mat, jog, and e-pen may be executed (1) the e-pen is in communication and/or removably coupled to the mat and is receiving a fluctuating current from the charging mat that charges the e-pen; (2) the e-pen is removably coupled to the jog and is receiving a fluctuating current from the jog that charges the e-pen; (3) the jog is removably coupled to the charging mat and is receiving a fluctuating current from the charging mat that charges the jog; (4) the e-pen is removably coupled to the jog, which is removably coupled to the charging mat such that the mat charges the jog, which, in turn, charges the e-pen. There may be various color or motion indicators (e.g., lights or vibration) that are employed to signal to a user and/or to other devices when charging is complete or when the device generating the fluctuating current is to be recharged. In any of (1)-(4) above, each of the e-pen, jog, or mat may maintain at least one functionality during charging (regardless of whether it is generating and/or receiving the fluctuating current used for wireless charging) such that both devices generating, transmitting, and receiving the fluctuating current may execute additional functions during charging without interrupting charging.

In other examples of a portable wireless charging system, a charging device may be configured in a first state as a charging mat as discussed above and, in a second state, may transform into a charging pouch in response to force applied to one or more points on the charging mat. This charging pouch comprises a battery and charging coils, and, when formed, comprises a plurality of interior coupling mechanisms designed to electrically couple to a plurality of computing and peripheral device types. This plurality of interior coupling mechanisms additionally mechanically couples to the devices while charging to hold the devices in place in the pouch while a user is traveling to prevent or at least mitigate damage done to the devices by any movement of the pouch and/or the user.

In one example in which a device is charging from the portable wireless charging system in the first state and where the system comprises a charging mat, the device—such as an e-pen—may charge from the charging system in the mat configuration of the first state while using the charging mat as an input surface such that markings made on the charging mat are transmitted to a monitor or tablet device that may or may not be coupled to the charging mat. In the same example, the charging mat, which may be referred to as a tray depending upon its geometry (since a “tray” may have a sunken surface whereas a “mat” may imply a substantially flat surface), is transformed into the charging pouch. Subsequently, the e-pen is coupled to an interior coupling mechanism of the pouch that is designed to electrically and mechanically couple to the e-pen such that the e-pen receives a fluctuating current from the charging pouch while it is coupled to the pouch. A computing device such as a mobile phone may also be coupled to a different interior coupling mechanism of the pouch for charging. In this example, the mobile phone maintains at least some functionalities while charging—that is, the mobile phone may continue to transmit and receive data over a network for application updates, data pushes, texting, email, and other data applications, and may also be used in an audio capacity. In one example where one surface of the pouch is substantially transparent, a computing device may be used for video or inputs to its interactive surface while the computing device is receiving a fluctuating current from the pouch, resulting in the computing device charging.

In one example, a portable wireless charging system comprises an e-pen that comprises a plurality of functionalities, a jog, and a charging mat. In a first state of the wireless charging system, the e-pen is to couple to the jog and to maintain a functionality of the plurality of functionalities while the e-pen is coupled to the jog. In a second state of the wireless charging system, the e-pen is to couple to the jog and the jog is to couple to the charging mat, and the charging mat is to generate a fluctuating current to be received by the e-pen, and the e-pen is to maintain the functionality of the plurality of functionalities. In this example, the e-pen further comprises a pen battery and a plurality of sensors, and the plurality of sensors are associated with the plurality of functionalities. In this example, the e-pen further comprises an antenna, a processor, a non-transitory memory, and an application stored in the non-transitory memory and executable by the processor to perform the plurality of functionalities, and the e-pen is to couple to the jog via a mechanical coupling mechanism or an electrical coupling mechanism. In this example, the plurality of functionalities comprises gaming, web browsing, financial transactions, document drafting, and computer-aided design drafting.

In one example, a portable wireless charging system comprises an e-pen which comprises a battery, a non-transitory memory, and an application stored in the non-transitory memory and executable by the processor to perform a plurality of functionalities, a jog that comprises a jog battery, and a charging mat. In this example, in a first state of the wireless charging system, the e-pen is to couple to the jog and to maintain a functionality of the plurality of functionalities while the e-pen is coupled to the jog. In a second state of the wireless charging system, the e-pen is to couple to the jog and the jog is to couple to the charging mat, and the charging mat is to generate a fluctuating current to be received by the e-pen, and the e-pen is to maintain a functionality of the plurality of functionalities. In a third state of the wireless charging system, the e-pen is to couple to the jog and the jog is to couple to the charging mat, and the charging mat is to generate a fluctuating current to be received by the e-pen, and the e-pen is to load and to execute a different functionality of the plurality of functionalities. Further in this example, in the third state of the wireless charging system, the application on the e-pen is to load and to execute the different functionality of the plurality of functionalities in response to coupling to the jog. In this example, the jog is to couple to the charging mat via a mechanical coupling mechanism or an electrical coupling mechanism. In this example, in a fourth state of the wireless charging system, the charging mat is to form a raised circumferential area around a perimeter of the charging mat and the e-pen is to couple to the charging mat via an electrical coupling mechanism. Furthermore in this example, a fourth state of the wireless charging system, a first surface of the charging mat is separated by a predetermined distance greater than zero from a second surface of the charging mat and the e-pen is to couple to the charging mat via an electrical coupling mechanism and a mechanical coupling mechanism.

In an example, a portable wireless charging system comprises an e-pen that comprises a battery, a non-transitory memory, and an application stored in the non-transitory memory and executable by a processor to perform a plurality of functionalities. In this example, the portable wireless charging system further a jog comprises a jog battery and a charging mat. In a first state of the wireless charging system, the e-pen is to couple to the jog and to maintain functionality of the plurality of functionalities while the e-pen is coupled to the jog. In a second state of the wireless charging system, the e-pen is to couple to the charging mat, and the charging mat is to generate a fluctuating current to be received by the e-pen, and the e-pen is to execute a different functionality of the plurality of functionalities. In this example, the jog is to couple to the charging mat via a mechanical coupling mechanism or an electrical coupling mechanism. In a third state of the wireless charging system, the e-pen is to couple to the jog and the jog is to couple to the charging mat, and the charging mat is to generate a fluctuating current to be received by the e-pen, and the e-pen is to maintain the functionality of the plurality of functionalities. Furthermore, in this example, e-pen comprises a biometric sensor and the application is executed by the processor to perform a functionality based on an input received from the biometric sensor.

FIG. 1 is a partial schematic cross-section of an example electronic pen 100. In the cross-section of the e-pen 100, a first side 102 comprises a first side portion 102b housing a writing tip 102a and a first plurality of controls 104. The writing tip 102a is electrically and physically coupled to the first plurality of controls 104. At least one first side sensor 106 may be disposed in a body 128, as may a biometric sensor 108, a rechargeable battery 110, a printed circuit board (PCB) 112, and at least one communication component 114. The PCB 112 may comprise a processor 114 that executes an application 120 stored in a non-transitory memory 118 of the PCB 112. In one example, a wireless charging region 122 may comprise one or more charging coils that may provide a fluctuating current to and/or receive a fluctuating current from multiple devices, including the jog and mat discussed herein, during a charging process. While the first plurality of controls 104 is illustrated as being in the first side portion 102b, in alternate examples, its position may be switched with the at least one first side sensors 106 such that the first side sensor 106 receives a signal from the writing tip 102a, and is electrically and/or mechanically coupled to the first plurality of controls 104 which may be in communication with other components such that the signals transmitted by the writing tip 102a are ultimately represented as a plurality of markings on an interactive surface (not shown). The various components of the electronic pen may be coupled to each other, either directly or indirectly, to achieve the functionality attributed herein to the electronic pen.

In some examples, a second side sensor 124 is electrically and/or mechanically coupled to a second tip 126a, and a plurality of secondary controls 116 are disposed in the second tip 126a in the portion 126b located at the second side 126. In this example, the plurality of secondary controls 116 are electrically and/or mechanically coupled to the second side sensor 124 and transmit a signal to the sensor 124 when the second tip 126a is activated and/or compressed as discussed herein. While the second side sensor 124 is shown as being located within the body 128, in some examples, the second side sensor 124 may be located in the second side portion 126b. In that example, the plurality of secondary controls 116 may be located adjacent to the at least one communication component 114, which may comprise an antenna. In various examples, the second side sensor 124 may comprise a pressure, temperature, level, or a combination of sensors that communicate with components of the e-pen as well as those of an interactive surface.

The rechargeable battery 110 powers the e-pen's functions and components, such as the first side sensor 106, the biometric sensor 108, the second side sensor 124, and the pluralities of controls 104 and 116. In some examples, the first plurality of controls 104 is powered by the battery 110 and receives and processes signals such as pressure (e.g., using a pressure sensor) and angle signals (e.g., using an accelerometer, a gyroscope, or a combination thereof) from the writing tip 102a, where the angle is the relative position of the writing tip 102a with respect to an interactive surface. The signals received by the first plurality of controls 104 from the writing tip 102a may be transmitted to the first side sensor 106. The first side sensor 106 communicates with a processor executing at least one application in an electronic whiteboard or other interactive surface (not shown) to transform the motion of the writing tip 102a of the e-pen 400 to markings on the interactive surface that are drawn according to a profile that is active and loaded on the e-pen 400 and/or the whiteboard. In another example, a plurality of sensors such as a proximity sensor, touch sensor, and active pen technology logic may be stored in either the first side 102, the second side 126, or the body portion 128, for example, as a part of the secondary controls 116.

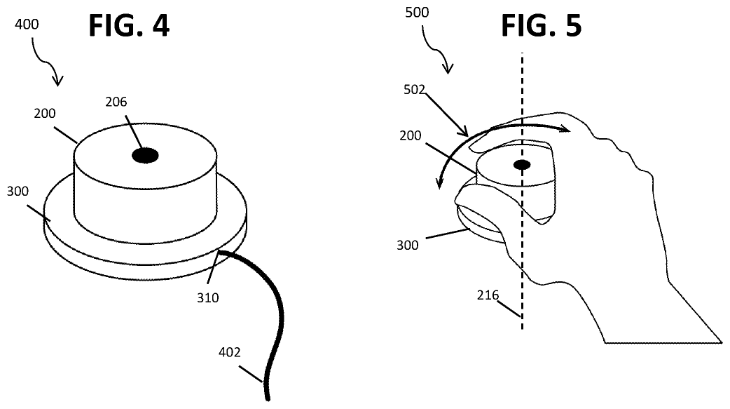

The plurality of secondary controls 116 may be powered by the battery 110 and configured to communicate with components of the e-pen 400A as well as an interactive surface as discussed below in FIG. 4A. The biometric sensor 108 may receive biometric inputs and the secondary controls 116 may transmit the biometric inputs to the whiteboard and/or to compare the input(s) to profiles stored on the e-pen or the whiteboard, depending upon the system configuration. The at least one communication component 114 facilitates communications between the e-pen and an interactive surface and may comprise an antenna such as a near-field communication (NFC) or other antenna and/or a module providing at least one of Bluetooth and Wi-Fi capabilities. The e-pen 100 may be employed in various wireless portable charging systems as discussed below.

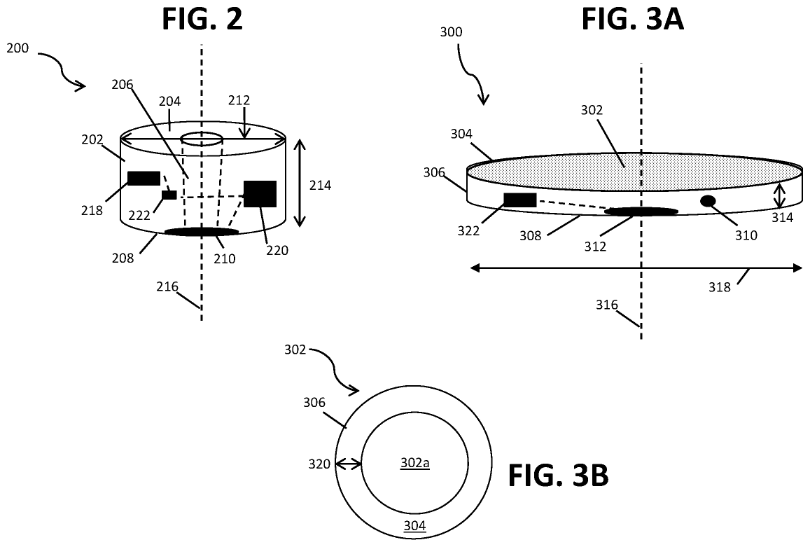

FIG. 2 is a partial schematic illustration of an example of a jog 200 according to certain example portable wireless charging systems of the present disclosure. The jog 200 comprises an outer surface 202 that defines an outer diameter 212 and further comprises a height 214. In some examples, the outer diameter 212 is greater than the height 214, and in other examples, the outer diameter 212 may be less than the height 214. A central axis 216 is perpendicular to a first surface 204 and second surface 208 of the jog 200 which are substantially parallel to each other. The jog 200 may be fabricated using various polymers and metallic, and may comprise a permanent or removable non-slip material on all or part of the second surface 208 so that, when used as a stand-alone device or when coupled to a device during charging (either as charger or charge recipient), it is stable. Thus, the jog may be configured as a solid outer casing or in a manner that makes the jog rotatable with respect to its second surface 208 without the rotation or movement of the second surface 208.

A first coupling mechanism 206 may be formed in the jog 200. In some examples, the first coupling mechanism 206 may be formed in the first surface 204. This first coupling mechanism 206 may be recessed from the first surface 204 and configured to mate with an e-pen similar to that shown in FIG. 1. While the first coupling mechanism 206 is shown as being centered along the central axis 216, in alternate examples, it may be offset from the central axis 216. In other examples, the first coupling mechanism 206 may comprise more than one individual coupling mechanism designed to hold one or more e-pens or other devices. In one example, the first coupling mechanism 206 may be located in the jog 200 so as to provide a current from a second coupling mechanism 210 to a device mated with the first coupling mechanism 206, thus wirelessly charging the battery of that device.

In one example, the second surface 208 comprises the second coupling mechanism 210 which may comprise one or more charging mechanisms such as charging coils that are employed to wirelessly charge the jog 200 as well as devices coupled to the first coupling mechanism 206. In one example, the second coupling mechanism 210 may be configured to electrically and/or mechanically couple to a device that provides charge to the jog 200, such as the charging mat 300, discussed below in FIG. 3. In one example, the jog 300 comprises a plurality of logic stored in a non-transitory memory 218 and a battery 220. The memory 218 may comprise additional elements such as applications executable by a processor 222, and the plurality of logic may be associated with device charging parameters for various types and/or brands of wirelessly chargeable devices. The battery 220 may be at least electrically coupled to the second coupling mechanism 210 such that the charging coils of the second coupling mechanism 210 charge the battery 220 when a fluctuating current is received by the charging mechanism 210.

The jog 200 may comprise a plurality of functionalities stored in the memory 218 and executable by the processor 222 including: charging the e-pen 100 or other devices, as well as selection, gaming, drawing, navigation, application execution, and other functionalities and may maintain these functionalities and/or gain functionalities when coupled to either the e-pen 100 or the mat 300. As discussed in FIG. 3, the second coupling mechanism may be removably coupled to and receive a charge from other devices via the second coupling mechanism 210. In some examples, the first 206 and second 210 coupling mechanisms may comprise one or more magnets that may be capable of magnetic storage and are employed to both removably couple the jog 200 and devices to which the jog 200 is coupled into place. These magnets may comprise readable information about various devices that may be used to execute functionalities of those devices while charging. Thus, the jog 200 may be employed as a stand-alone peripheral device that may execute or continue the execution of various functionalities including its use as a selection tool and providing charge to other devices while the jog 200 is simultaneously being charged. In some examples, the jog 200 comprises a plurality of sensors (not shown) that may determine a position, rotation angle and/or speed, inclination, motion, and/or other aspects of jog 200 use that may be employed in the execution of various functionalities of the jog 200. In some examples, the jog 200 may comprise additional components not illustrated here, including an additional non-transitory memory, additional batteries, USB ports or other ports, applications stored in the non-transitory memory, a processor that is to execute the applications, and components that enable WiFi, Bluetooth, RFID, and near-field communication (NFC).

FIGS. 3A and 3B are partial schematic illustrations of a charging mat 300 (“mat”) according to certain examples of the present disclosure. FIG. 3A is a partial schematic view of an example mat 300 perpendicular to a central axis 316 and FIG. 3B is a top-down view along the central axis 316. In one example, the mat 300 comprises an outer surface 306 that defines an outer diameter 318 of the mat 300. A first surface 302 may be substantially parallel to a second surface 308, and both surfaces 302 and 308 are perpendicular to the central axis 316. The second surface 308 may comprise a non-slip coating such as a rubberized coating, such that the use of peripheral or computing devices in conjunction with the mat 300 does not cause the mat 300 to slip or move relative to the surface on which it is disposed.

In one example, an outer region 304 of the first surface 302 may be raised as a “rib” as compared to the area of the first surface 302 such that the second surface 208 of the jog 200 in FIG. 2 or the e-pen 100 in FIG. 1 can be removably coupled to the jog 200, for example, via a plurality of magnets in the jog 200 and in the first surface 302 by magnetically securing the jog 200 into place inside of the rib. In another example, as shown in FIG. 3B which illustrates the top view of the first surface 302, the outer edge 304 may be formed as a rim with a width 320, and form a portion 302a of the first surface 302 that has a smaller height (depth) than the height 314. This portion 302a may enable the mechanical coupling of the jog 200 to the mat 300. The magnets that may be used for coupling, while not shown, may be located in the portion 302a and/or in the rim 304, depending upon the example, and may take various shapes and strengths and may in some examples include stored, readable media.

Turning back to FIG. 3A, the mat 300 may further comprise a first coupling region 312 that may be formed along the second surface 308 or elsewhere in the body of the mat 300. This coupling region 312 may be to removably couple to the region 210 of the jog 200 and/or to the wireless charging region 122 of the e-pen 100, discussed above. The mat 300 may further comprise a port 310 that may be employed to power the mat 300 during use, and/or to power a battery 322 of the mat 300. In one example, the battery 322 may be electrically coupled to the first coupling region 312 of the mat 300, and may receive a charge from the first coupling region 312 that enables the mat 300 to both operate as an interactive surface and to charge other devices that are in communication with the first coupling region 312 when the port 310 is not connected to an external power source. That is, the charging mat 300 may be wirelessly employed as an interactive surface and as a charging device or both simultaneously, with or without a connection to an outside power source. This, in combination with the wirelessly chargeable batteries of peripheral and computing devices that may be removably coupled to the mat 300 and/or to each other, enables the wireless charging system to be a portable wireless charging system. FIGS. 3A and 3B are partial views of the mat 300, which, when it is to function as an interactive surface, may comprise additional components not illustrated here, including a non-transitory memory, additional batteries, USB ports or other ports, applications stored in the non-transitory memory, a processor that is to execute the applications, and components that enable WiFi, Bluetooth, RFID, and near-field communication (NFC).

FIG. 4 is a partial schematic illustration of an example portable wireless charging system 400. The system 400 comprises a jog 200 coupled to a mat 300, which has a power cord 402 that is partially illustrated extending from the power port 310 discussed in FIG. 2. The charging mat 300 may be employed while the power cord 402 is coupled to a power source as well as when the power cord 402 is not coupled to a power source. As discussed above, this coupling may result in wireless charging of the jog 200 or other devices that are capable of receiving a fluctuating current from the mat 300. Stated another way, the charging mat 300 is to generate a fluctuating current to be received by the jog 200, and this current charges the jog 200. The fluctuating current may be generated in the charging mat 300 via the coupling region 312 shown in FIG. 3 that may comprise at least one coil configured to generate the fluctuating current which is received by the coupling region 210 of the jog 200, as shown in FIG. 2.

FIG. 5 is a partial schematic illustration of an example portable wireless charging system 500 during charging of the jog 200 by the mat 300. In particular, FIG. 5 shows the functionality of the jog 200 while it is coupled to the mat 300. The jog 200 may be partially (less than 360 degrees) or completely (360 degrees) manually rotated in either direction around the central axis 216 as illustrated by the arrows 502. This rotation enables the jog 200 to be used as a selection and/or writing tool, or for gaming, design, and other functionalities while it is coupled to the mat 300 (as shown) and charging. The jog 200 may be used in a similar fashion when uncoupled from the mat 300, as shown in at least FIG. 2 and discussed above.

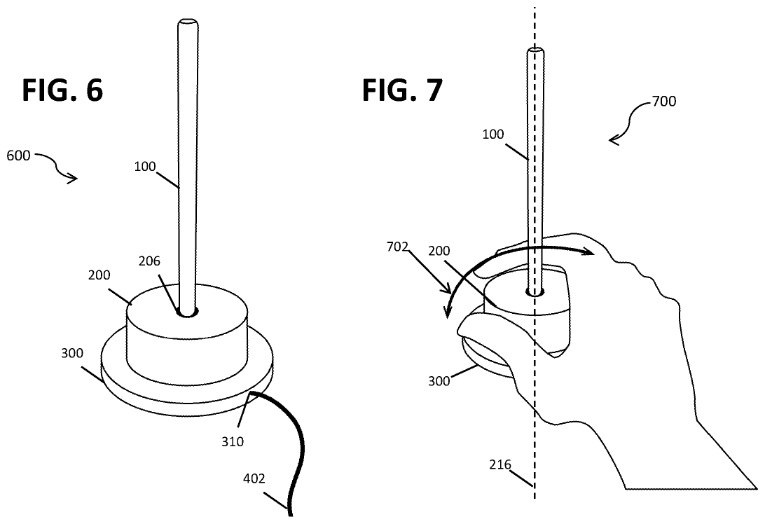

FIG. 6 is a partial schematic illustration of a wireless charging system 600. The system 600 comprises an e-pen 100 coupled to a jog 200 while the jog 200 is coupled to a mat 300. The mat 300 has a power cord 402 that is partially illustrated extending from the power port 310 discussed in FIG. 2 and which may or may not be connected to an external power source while the mat 300 is providing the charge to the jog 200 and/or to the e-pen 100 via the jog 200. Thus, and as discussed above, the charging mat 300 may be employed while the power cord 402 is coupled to a power source as well as when the power cord 402 is not coupled to a power source. Also discussed above, this coupling may result in wireless charging of the jog, that is, the charging mat 300 is to generate a fluctuating current to be received by the jog 200, and the jog 200 is mechanically and electrically coupled to the e-pen 100 via 206. The fluctuating current may be generated in the charging mat 300 via the coupling region 312 shown in FIG. 3 that may comprise at least one coil to generate the fluctuating current which is received by the coupling region 210 of the jog 200, as shown in FIG. 2. The fluctuating current generated by the mat 300 may additionally be received by the e-pen 100 via the jog 200 via the wireless charging region 122 of the e-pen 100 (as shown in FIG. 1).

FIG. 7 is a partial schematic illustration of an example portable wireless charging system 700. In particular, FIG. 7 shows the functionality of the jog 200 while it is coupled to the mat 300 and to the e-pen 100. The jog 200 may be used as a selection and/or writing tool, or for gaming, design, and other functionalities while it is being charged and is coupled to the mat 300 (as shown) and while it is coupled to the e-pen 100. The jog 200 may maintain or increase its functionalities while charging from the mat 300 and providing a charge to the e-pen 100. In some examples, the jog 200 may also be used as a tool when it is uncoupled from the mat 300 (as shown in FIG. 2) and when it is only coupled to the e-pen 100 (not shown) and not coupled to the mat 300. The jog 200 may be partially (less than 360 degrees) or completely (360 degrees) manually rotated around the central axis 216 as illustrated by the arrows 702.

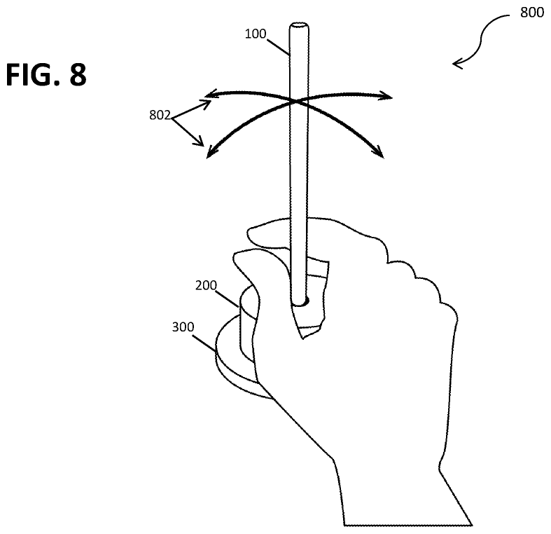

FIG. 8 is a partial schematic illustration of an example portable wireless charging system 800. In particular, FIG. 8 shows the continued functionality of the e-pen 100 while it is coupled to the mat 300 via the jog 200. The e-pen may be used as a selection and/or writing tool, or for gaming, design, and other functionalities while it is coupled to the jog 200 (as shown), and, additionally, when coupled to the mat 300 but not to the jog 200 (not shown). The e-pen 100 may be partially (less than 360 degrees) or completely (360 degrees) manually rotated around the central axis 216 as illustrated by the arrows 802, and/or may also be moved in directions perpendicular to the central axis 216, or in other directions depending upon the functionality of the e-pen 100 executed while the e-pen 100 is receiving a charge from the jog 200.

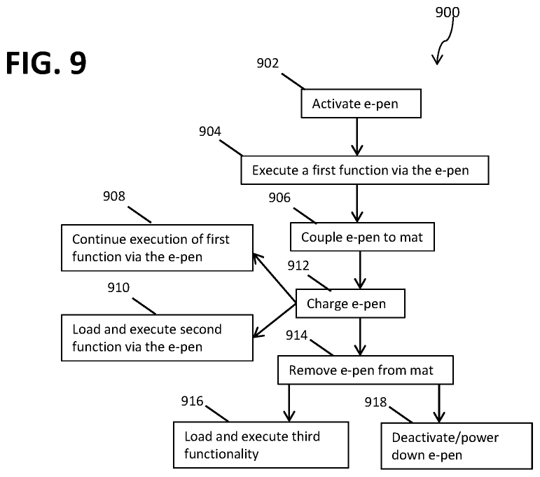

FIG. 9 is an example method 900 of a portable wireless charging platform. In the example method 900, at block 902, an e-pen is activated via a biometric input, a motion or gesture, a physical activation via the e-pen, or other method of activating an e-pen such that execution of a first functionality of the e-pen is performed at block 904. These functionalities may include gaming, drawing, drafting documents, generating markings (including writing/exiting of texts and drafting/editing of figures), web browsing, or other functionalities associated with the use of an e-pen with various peripheral devices such as the jog and/or charging mat and interactive surface discussed herein. At block 906, the e-pen may be electrically and/or mechanically coupled to a charging mat such that it is wirelessly charged at block 912. As discussed herein, this coupling may be mechanical, aided by magnets or other physical coupling mechanisms, and may be additionally or alternatively an electrical coupling, such that the e-pen receives a charge but is not coupled into a physical position with respect to the mat, which enables the use of the e-pen as a tool and the mat as an interactive surface.

In various examples, during (i.e., simultaneously with) the charging of the e-pen at block 912 via the charging mat, the e-pen may, at block 908, (1) continue execution of the first functionality executed at block 904 during charging and/or (2) responsive to a second input, load and/or execute a second functionality at block 910 that may be executed in place of or in addition to the first functionality. For example, if the first functionality at block 904 comprises a drawing/writing functionality on an interactive surface including the charging mat, this functionality may be maintained at block 908 while the e-pen is charged. In some examples, at block 910, a second functionality may be loaded and executed during charging. In one example, the second functionality is loaded from a non-transitory memory of the e-pen or via the e-pen communicating with a remote device, and may be loaded in response to a motion/gesture of the e-pen, a physical input to the e-pen such as a button or a switch, and/or a biometric input. In an example where the second functionality loaded at block 910 comprises web browsing and/or selection of various options on a display, the e-pen may maintain its first functionality as well.

In another example, where the second functionality loaded at block 910 comprises a gaming functionality, the first functionality loaded at block 904 may be unloaded as a part of the loading of the second functionality. In some examples, the e-pen may be configured to enable toggling between the functionalities discussed at blocks 904, 908, and 910. At block 914, the e-pen may be removed from the charging mat and may continue executing the first and/or second functionalities discussed at blocks 904, 908, and 910, may load a third, different functionality at block 916, or may be deactivated and/or powered down at block 918.

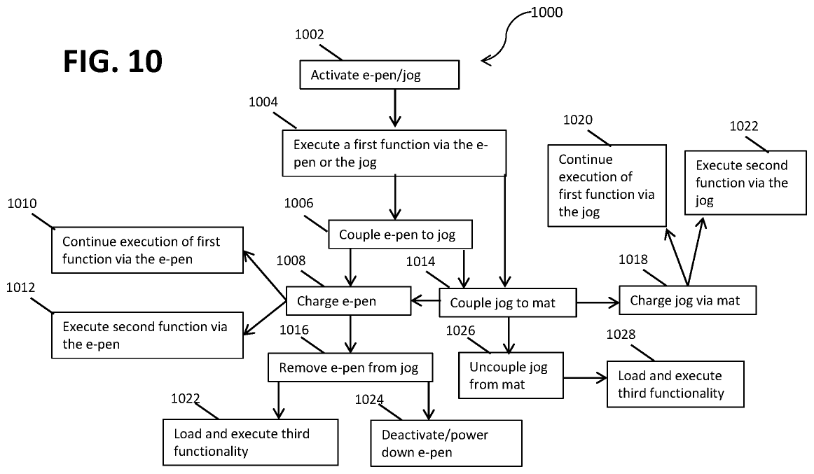

FIG. 10 is an example method 1000 of a portable wireless charging system. In the method 1000 at block 1002, an e-pen and/or a jog is activated via a biometric input, a motion or gesture, a physical activation, or other method of activating an e-pen and/or a jog such that execution of a first functionality of the e-pen and/or the jog may be performed at block 1004. For example, a jog may be able to function as a selection tool or in additional capacities when it is coupled to or uncoupled from an e-pen or a charging mat. At block 1006, the e-pen may be electrically and/or mechanically coupled to the jog such that the jog provides a fluctuating current to the e-pen which wirelessly charges the e-pen at block 1008.

In one example, during the charging of the e-pen at block 1008 via the jog, the e-pen may, at block 1010, (1) continue execution of the first functionality executed at block 1004 during charging and/or (2) responsive to a second input, load and/or execute a second functionality at block 1012 that may be executed in place of or in addition to the first functionality. In a similar fashion, the jog may also maintain an executing and/or loaded functionality while charging, as discussed herein. For example, if the first functionality at block 1004 comprises a drawing/writing functionality on a smart surface or on the charging mat, this functionality may be maintained at block 1010. At block 1012, a second functionality may be loaded from a non-transitory memory of the e-pen or via the e-pen communicating with a remote device, and may be loaded in response to a motion/gesture of the e-pen, a physical input to the e-pen such as a button or a switch, and/or a biometric input. At block 1016, the e-pen may be removed (uncoupled) from the jog and a third functionality that is different from the first and the second functionalities may be loaded by the e-pen at block 1022 or the e-pen may be deactivated or powered down at block 1024.

In another example as shown in the method 1000, the jog may be coupled to a charging mat at block 1014 with or without the jog being removably coupled to the e-pen at block 1006. At block 1018, subsequent to the jog being removably coupled electrically and/or mechanically to the jog, the jog is wirelessly charged via the mat by receiving a fluctuating current from the mat. In this example, the first functionality executed by the jog at block 1004 may be maintained at block 1020 during the charging at block 1018. In another example, during charging of the jog at block 1018, a second functionality is loaded and executed at block 1022. Similarly to the e-pen as discussed above, the jog may maintain one or more different functionalities at the same time while charging and/or while being charged, or may unload the first functionality as a part of loading the second functionality at block 1022.

At block 1026, the jog may be uncoupled from the charging mat, and may maintain one or more functionalities loaded and executed at blocks 1004 and 1022, or may load and execute an additional third functionality at block 1028 once decoupled from the mat. In some examples, a particular functionality may have been loaded at block 1004 that, based on a plurality of rules stored in the jog or in a remote device in communication with the jog, may not be desirable to execute during jog charging at block 1018. In this example, in response to uncoupling from the mat at block 1026, the first functionality from block 1004 may be re-enabled (not illustrated).

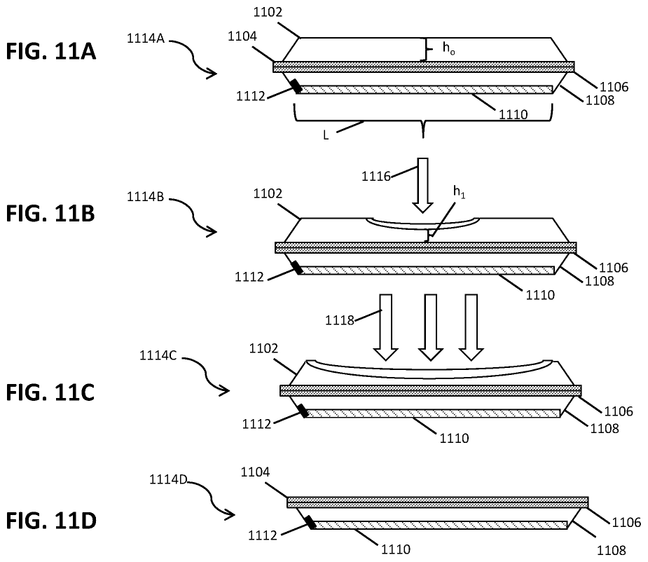

In some examples, a portable wireless charging system may comprise a collapsible pouch that may be collapsed into a charging tray. FIGS. 11A-11D are partial schematic illustrations of an example portable wireless charging system's transformation from a closed pouch at FIG. 11A to a collapsed tray at FIG. 11D. The closed pouch 1114A in FIG. 11A comprises features including a first portion 1102 with a height of h₀, and a second portion 1108 that is parallel to the first portion 1102. A first rib 1104 is adjacent to a second rib 1106 and the ribs are flush with each other such that there is no visible gap between the ribs 1104 and 1106 when the pouch is in a closed state. The second portion 1108 may comprise a battery 1110 that may also be referred to as a charging region 1110 that is configured to apply a fluctuating current to a plurality of devices (not shown). In some examples, the battery 1110 may extend across a length L of the second portion 1108, and in alternate examples, it may extend across less than the length “L” of the second portion 1108 and may be located off-set from a central axis 1116. In one example, the second portion 1108 may further comprise a port 1112 that may be located as shown in FIG. 11A or that may be located otherwise adjacent to and removably electric and/or mechanically coupled to the battery 1110. While the partial cross-sectional views 1114A-1114D in FIGS. 11A-11D are illustrated such that the first 1102 and second 1108 portions each comprise a trapezoidal shape, in alternate examples, one or both portions 1102, 1108 may, in the closed pouch state in FIG. 11A, comprise a square, rectangular, rounded-edge, or other geometry.

In the example at FIG. 11B, a force is applied to the first portion 1102 as indicated by the arrow 1116. While the force applied in FIG. 11B is illustrated by the arrows 1118 as being substantially perpendicular to the first portion 1102, in other examples, forces may be applied at directions that are less than perpendicular with respect to the first portion 1102. As shown in FIG. 11B, the force 1118 applied reduces the height of the first portion (h₀ in FIG. 11A) to h1, which is less than h₀. FIG. 11C illustrates a partial schematic illustration 1114C that shows an increase in the collapsed portion of the first portion 1102, and FIG. 11D illustrates a collapsed pouch 1114D that may be referred to as a charging mat or tray 1114D. In FIG. 11D, the first portion 1102 is not visible as it is collapsed into the second portion 1108 as to form a charging surface for a plurality of wirelessly chargeable devices via the battery 1110.

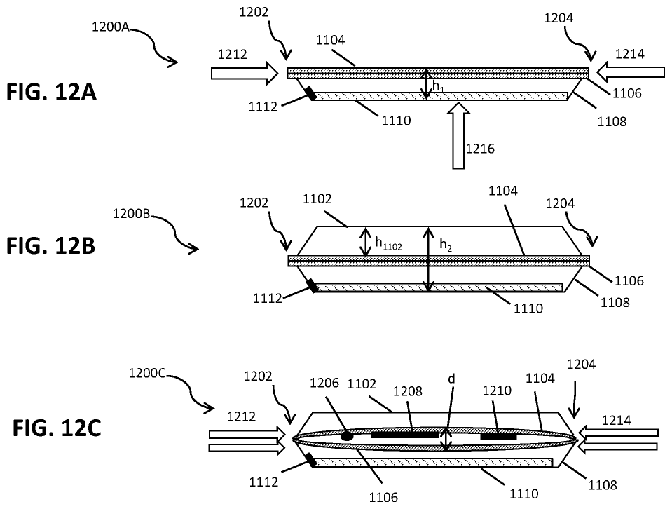

FIGS. 12A-12C illustrate how an example portable wireless charging system transforms from a first tray state to a second pouch state. FIG. 12A is substantially similar to FIG. 11D, and illustrates a portable wireless charging system in a first tray state that may also be referred to as a collapsed pouch 1200A. In the tray 1200A raised lips 1104 and 1106 create a depth in an internal surface (not pictured but substantially equal to the height hᵢ) that may be used as a charging mechanism via the battery 1110 and/or as a writing or other input surface. FIG. 12A additionally illustrates a first side 1202 and a second side 1204 of the collapsed pouch 1200A. When force is applied in any or all of the directions 1212, 1214, and 1216 as shown by the arrows in FIG. 12A, the first portion 1102 “pops up” in the direction of arrow 1216. That is, in response to the application of force in FIG. 12A, the collapsed pouch 1200A with a height h₁ expands into the pouch 1200B in FIG. 12B that has a height h₂, which is greater than the height h₁ by the height h₁₁₀₂ of the first portion 1102. Expressed mathematically, h₂=(hᵢ+h₁₁₀₂). In one example, the height h₂ is from about 0.5″ to about 2.5″ and the height h₁ is from about 0.1″ to about 2.5″. In FIG. 12C, a partial schematic illustration of an opened wireless charging pouch 1200C is shown. The opened wireless charging pouch is formed by the simultaneous application of force to the first side 1202 and second side 1204 as shown by the arrows 1212 and 1214 in FIG. 12C. Once the pouch 1200C is expanded such that the ribs 1104 and 1106 are separated by a distance d that may be from about 0.10″ to about 2.0,″ a plurality of devices may be removably coupled to a plurality of device-specific coupling mechanisms 1206, 1208, and 1210, that may be configured to removably couple to e-pens, mobile phones, audio devices, tablets, and other wirelessly chargeable peripheral and computing devices. In one example, the portable wireless charging system of FIGS. 12A-12D may charge a plurality of devices simultaneously, and, in some examples, the system may allocate charge based on a relative charge of each of the devices coupled to the system.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

What is claimed is:

1. A portable wireless charging system, comprising:
an e-pen comprising a plurality of functionalities;
a jog; and
a charging mat;
wherein, in a first state of the wireless charging system, the e-pen is to couple to the jog and to maintain a functionality of the plurality of functionalities while the e-pen is coupled to the jog, and
wherein, in a second state of the wireless charging system, the e-pen is to couple to the jog and the jog is to couple to the charging mat, and the charging mat is to generate a fluctuating current to be received by the e-pen, and the e-pen is to maintain the functionality of the plurality of functionalities.

2. The system of claim 1, wherein the e-pen further comprises a pen battery and a plurality of sensors, wherein the plurality of sensors are associated with the plurality of functionalities.

3. The system of claim 1, wherein the e-pen further comprises an antenna, a processor, a non-transitory memory, and an application stored in the non-transitory memory and executable by the processor to perform the plurality of functionalities.

4. The system of claim 1, wherein the plurality of functionalities comprises gaming, web browsing, financial transactions, document drafting, and computer-aided design drafting.

5. The system of claim 1, wherein the e-pen is to couple to the jog via a mechanical coupling mechanism or an electrical coupling mechanism.

6. A portable wireless charging system, comprising:
an e-pen comprising:
a battery;
a non-transitory memory; and
an application stored in the non-transitory memory and executable by the processor to perform a plurality of functionalities;
a jog comprising a jog battery; and
a charging mat;
wherein, in a first state of the wireless charging system, the e-pen is to couple to the jog and to maintain a functionality of the plurality of functionalities while the e-pen is coupled to the jog,
wherein, in a second state of the wireless charging system, the e-pen is to couple to the jog and the jog is to couple to the charging mat, and the charging mat is to generate a fluctuating current to be received by the e-pen, and the e-pen is to maintain a functionality of the plurality of functionalities, and
wherein, in a third state of the wireless charging system, the e-pen is to couple to the jog and the jog is to couple to the charging mat, and the charging mat is to generate a fluctuating current to be received by the e-pen, and the e-pen is to load and to execute a different functionality of the plurality of functionalities.

7. The system of claim 6, wherein, in the third state of the wireless charging system, the application on the e-pen is to load and to execute the different functionality of the plurality of functionalities in response to coupling to the jog.

8. The system of claim 6, wherein the jog is to couple to the charging mat via a mechanical coupling mechanism or an electrical coupling mechanism.

9. The system of claim 6, wherein, in a fourth state of the wireless charging system, the charging mat is to form a raised circumferential area around a perimeter of the charging mat and the e-pen is to couple to the charging mat via an electrical coupling mechanism.

10. The system of claim 6, wherein, in a fourth state of the wireless charging system, a first surface of the charging mat is separated by a predetermined distance greater than zero from a second surface of the charging mat and the e-pen is to couple to the charging mat via an electrical coupling mechanism and a mechanical coupling mechanism.

11. A portable wireless charging system, comprising:
an e-pen comprising:
a battery;
a non-transitory memory; and
an application stored in the non-transitory memory and executable by a processor to perform a plurality of functionalities;
a jog comprising a jog battery; and
a charging mat;
wherein, in a first state of the wireless charging system, the e-pen is to couple to the jog and to maintain functionality of the plurality of functionalities while the e-pen is coupled to the jog,
wherein, in a second state of the wireless charging system, the e-pen is to couple to the charging mat, and the charging mat is to generate a fluctuating current to be received by the e-pen, and the e-pen is to execute a different functionality of the plurality of functionalities.

12. The system of claim 11, wherein the jog is to couple to the charging mat via a mechanical coupling mechanism or an electrical coupling mechanism.

13. The system of claim 11, wherein, in a third state of the wireless charging system, the e-pen is to couple to the jog and the jog is to couple to the charging mat, and the charging mat is to generate a fluctuating current to be received by the e-pen, and the e-pen is to maintain the functionality of the plurality of functionalities.

14. The system of claim 11, wherein the e-pen comprises a biometric sensor.

15. The system of claim 14, wherein the application is executed by the processor to perform a functionality based on an input received from the biometric sensor.
